(19) United States
(12) Patent Application Publication
(10) Pub. No.: US 2014/0090497 A1
(43) Pub. Date: Apr. 3, 2014

(54) SPRING LOADED SHAFT ASSEMBLY

(71) Applicant: AUBURN GEAR, INC., Auburn, IN (US)

(72) Inventor: Michael J. Eifert, Fort Wayne, IN (US)

(73) Assignee: AUBURN GEAR, INC., Auburn, IN (US)

(21) Appl. No.: 13/645,096

(22) Filed: Oct. 4, 2012

Related U.S. Application Data
(60) Provisional application No. 61/708,401, filed on Oct. 1, 2012.

(51) Int. Cl. F16H 1/02; F16F 1/18

(52) U.S. Cl. CPC F16H 1/02; F16F 1/185
USPC 74/325; 267/161

(57) ABSTRACT

A disconnect shaft arrangement interposes a biasing element between a shoulder formed on the disconnect shaft and a cup-shaped washer, in which the cup-shaped washer is sized and configured to be axially displaceable with respect to the disconnect shaft. The cup-shaped washer selectively engages an axially fixed adjacent structure, such as a thrust washer, during disengagement of the disconnect shaft and attendant spring compression. The present disconnect shaft arrangement obviates the need for a retaining ring against which the spring compresses, such that the relatively deep retaining ring groove needed for such a retaining ring need not be cut into the outer surface of the disconnect shaft. Removal of material in the outer surface of the shaft is therefore minimized, such that the torque transmission capability of the shaft is maximized.

### CROSS REFERENCE TO RELATED APPLICATION

This application claims the benefit under Title 35, U.S.C. §119(e) of U.S. Provisional Patent Application Ser. No. 61/708,401, filed Oct. 1, 2012 and entitled SPRING LOADED SHAFT ASSEMBLY, the entire disclosure of which is hereby expressly incorporated by reference herein.

### BACKGROUND

1. Field of the Disclosure

The present disclosure relates to a spring biased shaft arrangement, and in particular, to a spring biased shaft used to selectively engage internal gearing of a transmission.

2. Description of the Related Art

Large industrial machinery, such as earth moving equipment and other construction vehicles, may use individual power transmission units mounted at the hub of each driven wheel. These individual power transmission units are sometimes referred to as “wheel drives” and may house a transmission device which provides large gear reduction for the heavy loads, large wheels and low speeds frequently employed by such vehicles. Wheel drives may receive power from a drive shaft drivingly connected to the vehicle power source and output a lower-speed, higher-torque rotation.

In some configurations, gearing mechanisms of wheel drives are selectively engageable with the driven input shaft, such that the wheel drive is configurable into driving and free-wheeling configurations. In the driving configuration, the input shaft is operably coupled to the output hub via the gearing mechanism, while the free-wheeling configuration renders the input shaft operably decoupled from the output hub such that the wheel is free to spin independent of influence by the vehicle power source. To achieve this selective engagement, some wheel drive units include a coupling shaft or sleeve which is axially displaceable to selectively engage the powered input to the gearing mechanism, and ultimately to the output hub. Generally speaking, such axially displaceable coupling shafts or sleeves are manipulated by the drive unit operator, either manually or automatically, to toggle the drive unit between engaged and disengaged configurations.

One known wheel drive unit with an axially translatable shaft which operates as a disconnect mechanism is disclosed in U.S. Pat. No. 6,607,049 to Cigal. A portion of this known mechanism is illustrated as disconnect mechanism 112 in FIGS. 1A and 1B. Mechanism 112 includes disconnect shaft 114, which is axially displaceable between engaged and disengaged positions. More particularly, shaft 114 is shown in the engaged position in FIG. 1A, in that shaft 114 is rotatably fixed to both input coupler 118 and output gear 122, thereby transferring motive force and torque therebetween. Spring 168 is compressed by application of force F (FIG. 1B) when disconnect shaft 114 is moved from the engaged position to the disengaged position, and operates to bias shaft 114 back toward the engaged position. Spring 168 is interposed between thrust washers 178 positioned at respective axial terminal ends of spring 168. At the input-side axial end of spring 168, thrust washer 178 abuts a shoulder formed in the spindle of the wheel drive, while the output-side axial end of spring 168 utilizes retaining ring 124. Retaining ring 124 is connected to a corresponding groove formed in disconnect shaft 114. The retaining ring groove formed in shaft 114 reduces the overall diameter of shaft 114 in the vicinity of retaining ring 124, by a sufficient amount that the minor diameter of shaft 114 (i.e., the smallest diameter) is the diameter of the retaining ring groove.

In the context of wheel drive mechanisms, substantial force and torque may be transmitted via the above described axially translatable disconnect shafts. Accordingly, it is desirable to produce disconnect shaft arrangements and assemblies which maximize power transmission capability while avoiding unnecessary cost, weight and/or size. Therefore, what is needed is a disconnect shaft arrangement that is robust, cost effective and capable of handling a large amount of torque and force for a given shaft size.

### SUMMARY

The present disclosure provides a disconnect shaft arrangement which interposes a biasing element between a shoulder formed on the disconnect shaft and a cup-shaped washer, in which the cup-shaped washer is sized and configured to be axially displaceable with respect to the disconnect shaft. The cup-shaped washer selectively engages an axially fixed adjacent structure, such as a thrust washer, during disengagement of the disconnect shaft and attendant spring compression. The present disconnect shaft arrangement obviates the need for a retaining ring against which the spring compresses, such that the relatively deep retaining ring groove needed for such a retaining ring need not be cut into the outer surface of the disconnect shaft. Removal of material in the outer surface of the shaft is therefore minimized, such that the torque transmission capability of the shaft is maximized.

In one form thereof, the present disclosure provides a transmission disconnect system including: a disconnect shaft axially moveable between an engaged position and a disengaged position along a longitudinal shaft axis, the disconnect shaft having a first end defining a first minor diameter and a second end opposite the first end; a first torque transmitter rotatably fixed to the first end of the disconnect shaft such that a torque is transmissible between the first torque transmitter and the disconnect shaft; a second torque transmitter rotatably fixed to the second end of the disconnect shaft when the disconnect shaft is in the engaged position and rotatably decoupled from the second end of the disconnect shaft when the disconnect shaft is in the disengaged position, such that the torque is transmissible from the first torque transmitter to the second torque transmitter via the disconnect shaft when the disconnect shaft is in the engaged position; a cup-shaped washer having a longitudinal washer axis, the cup-shaped washer including: a sidewall having an length measured along the longitudinal washer axis; and a mounting flange extending radially inwardly from a first terminal axial end of the sidewall to define a mounting bore having a diameter larger than the first minor diameter of the disconnect shaft, the first end of the disconnect shaft axially translatable within the mounting bore; a second axial end of the sidewall opposite the first axial end and defining a seating surface transverse to the longitudinal washer axis, the second axial end disposed nearer to the first end of the disconnect shaft than the first axial end when the cup-shaped washer is mounted to the disconnect shaft; and a biasing element constrained against axial displacement by the mounting flange of the cup-shaped washer and biasing the disconnect shaft into the engaged position.

In another form thereof, the present disclosure provides a transmission including a disconnect shaft axially moveable between an engaged position and a disengaged position along a longitudinal shaft axis, the disconnect shaft including a first end defining a first minor diameter; a second end opposite the first end; and a central portion disposed between the first end and the second end, the central portion defining a shoulder extending radially outward; an input coupler rotatably fixed to the first end of the disconnect shaft such that a torque is transmissible between the input coupler and the disconnect shaft; an output gear rotatably fixed to the second end of the disconnect shaft when the disconnect shaft is in the engaged position and rotatably decoupled from the second end of the disconnect shaft when the disconnect shaft is in the disengaged position, such that the torque is transmissible from the input coupler to the output gear via the disconnect shaft when the disconnect shaft is in the engaged position; a cup-shaped washer having a longitudinal washer axis, the cup-shaped washer including: a sidewall having an length measured along the longitudinal washer axis; and a mounting flange extending radially inwardly from a first terminal axial end of the sidewall to define a mounting bore having a diameter larger than the first minor diameter of the disconnect shaft, the first end of the disconnect shaft axially translatable within the bore; a second axial end of the sidewall opposite the first axial end and defining a seating surface transverse to the longitudinal washer axis; a seating structure interposed between the input coupler and the output gear, the seating structure axially fixed and having a bore large enough to allow passage of the disconnect shaft therethrough, the bore small enough to prevent passage of the second axial end of the cup-shaped washer therethrough; and a biasing element captured between the cup-shaped structure and shoulder of the disconnect shaft, such that the biasing element urges the seating surface of the cup-shaped washer toward the seating structure, and urges the disconnect shaft into the engaged position.

In yet another form thereof, the present disclosure provides a cup-shaped washer including: an annular sidewall having an length measured along a longitudinal washer axis; and a mounting flange extending radially inwardly from a first terminal axial end of the sidewall to define a mounting bore having a splined inner periphery adapted to be rotatably fixe to a splined outer surface of a shaft; and a seating flange extending radially outwardly from a second terminal axial end of the sidewall opposite the first terminal axial end, the seating flange defining a seating surface substantially perpendicular to the longitudinal washer axis.

### BRIEF DESCRIPTION OF THE DRAWINGS

The above-mentioned and other features and advantages of the present disclosure, and the manner of attaining them, will become more apparent and the invention itself will be better understood by reference to the following description of an embodiment of the invention taken in conjunction with the accompanying drawings, wherein:

FIG. 1A is a an elevation, cross-sectional view of a portion of a wheel drive utilizing a known spring loaded shaft assembly arrangement, with the disconnect shaft shown in an engaged position;

FIG. 1B is an elevation, cross-sectional view of the portion of the wheel drive of FIG. 1A, with the disconnect shaft shown in a disengaged position;

FIG. 2A is an elevation, cross-sectional view of a wheel drive transmission assembly utilizing a disconnect shaft arrangement made in accordance with the present disclosure, in which the disconnect shaft shown in an engaged position;

FIG. 2B is an elevation, cross-sectional view of a portion of the transmission assembly shown in FIG. 2A, illustrating the disconnect shaft in a disengaged position;

FIG. 3A is an elevation, cross-sectional partial view of the transmission disconnect system shown in FIG. 2A, illustrating only the disconnect shaft and adjacent components in their respective engaged configurations;

FIG. 3B is an elevation, cross-sectional view of the transmission disconnect system shown in FIG. 3A, with the components shown in their respective disengaged configurations;

FIG. 4 is a perspective view of a cup-shaped washer made in accordance with the present disclosure;

FIG. 5 is an elevation, cross-sectional view of the cup-shaped washer shown in FIG. 4;

FIG. 6A is an elevation, sectional view of a disconnect shaft made in accordance with the present disclosure; and

FIG. 6B is an enlarged elevation view of a portion of the shaft shown in FIG. 6A, illustrating a snap ring groove formed therein.

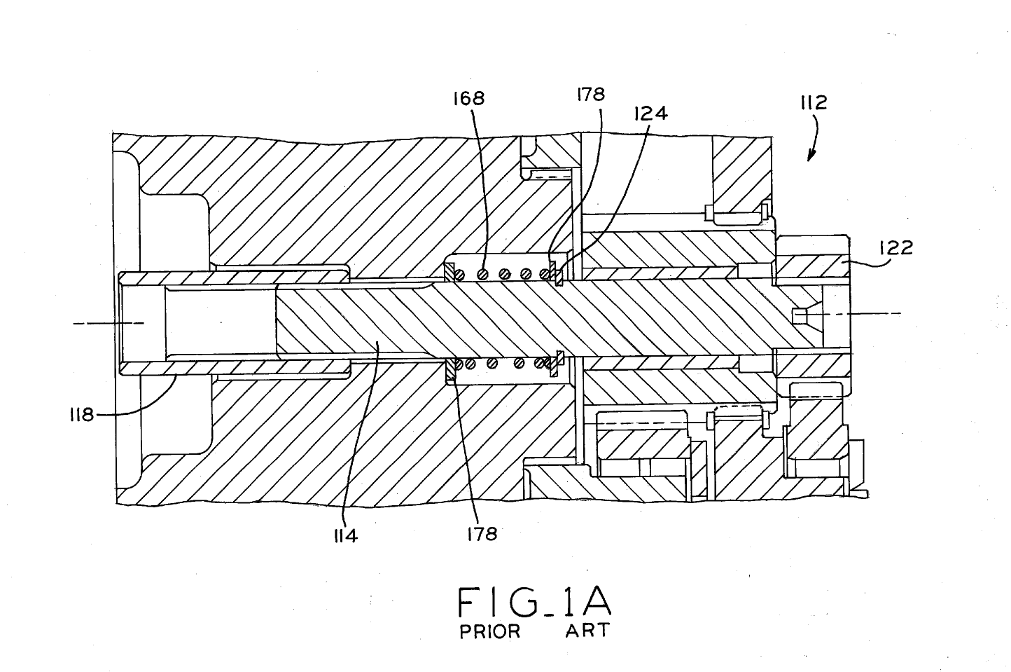

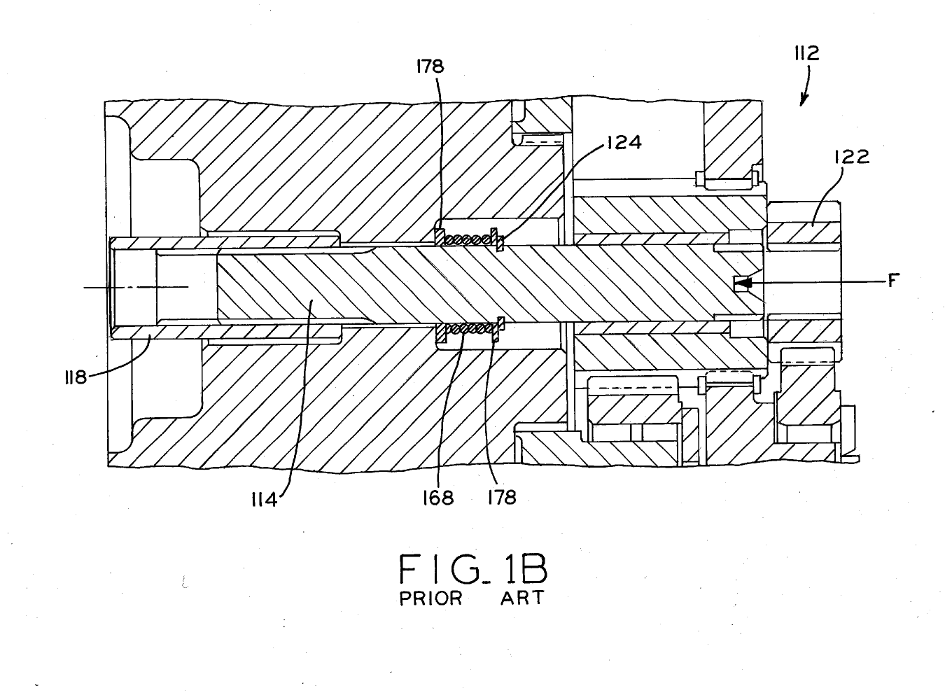

Corresponding reference characters indicate corresponding parts throughout the several views. The exemplification set out herein illustrates an exemplary embodiment of the invention, and such exemplification is not to be construed as limiting the scope of the invention in any manner.

### DETAILED DESCRIPTION

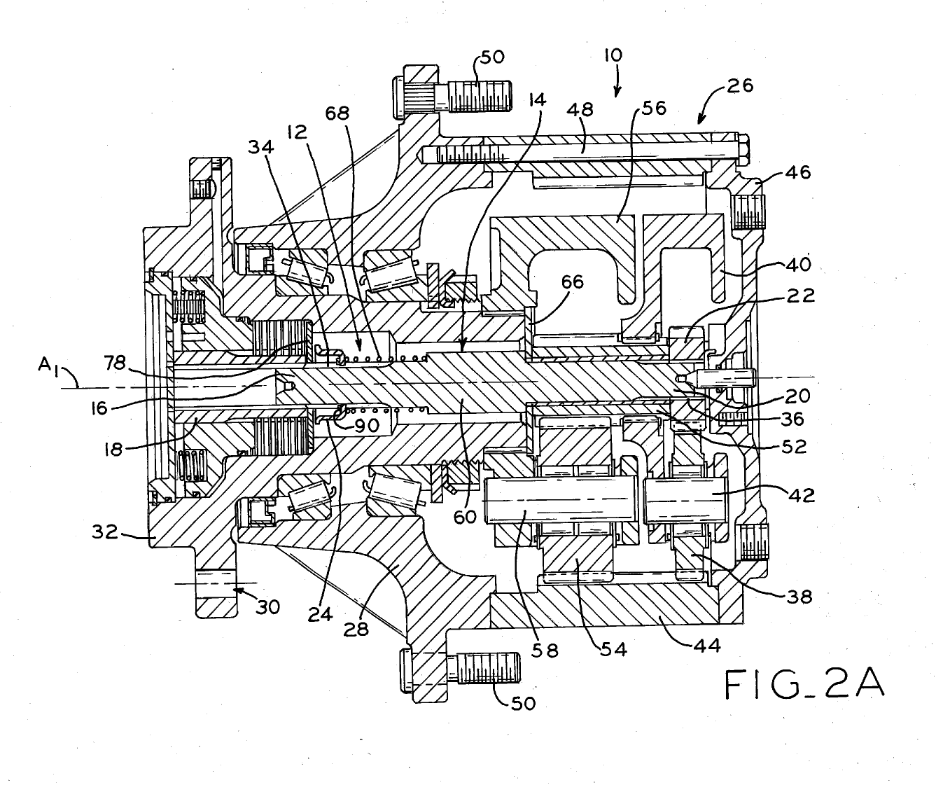

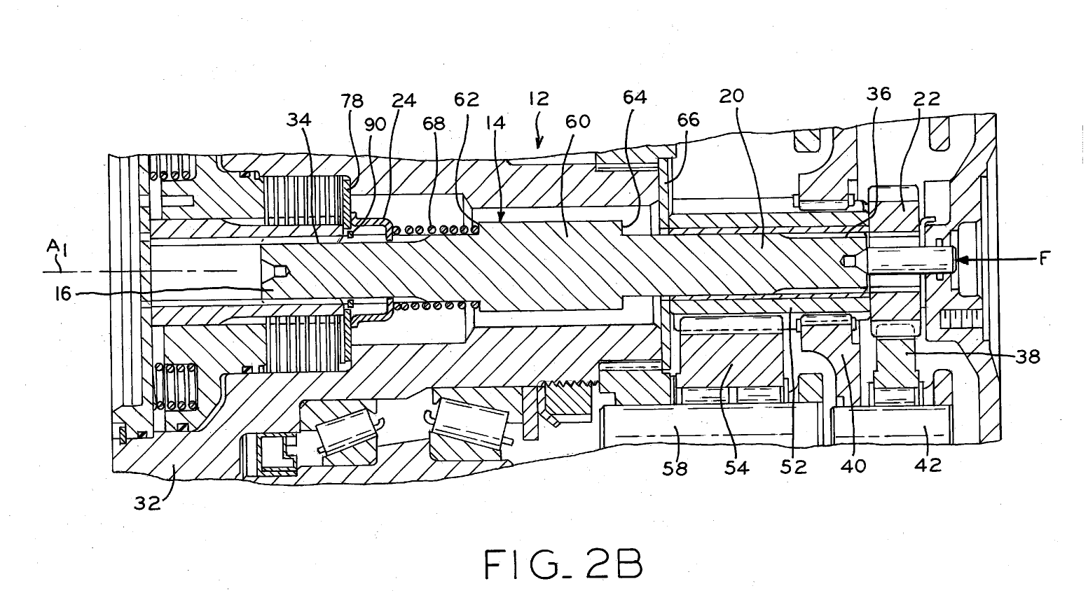

FIGS. 2A and 2B illustrate wheel drive transmission unit 10 including transmission disconnect system 12 in engaged and disengaged configurations, respectively. As described in detail below, transmission disconnect system 12 is engaged when disconnect shaft 14 has first end 16 rotatably affixed to input coupler 18, and has a second end 20 rotatably affixed to output gear 22. Thus, in the engaged position shown in FIG. 2A, disconnect shaft 14 rotatably fixes input coupler 18 to output gear 22. By contrast, FIG. 2B illustrates a disengaged configuration of transmission disconnect system 12 in which force F has been applied to disconnect shaft 14 to axially displace shaft 14 toward input coupler 18. When so displaced, second end 20 becomes rotatably decoupled from output gear 22. Although coupler 18 (having internal splines) and gear 22 (having external splines) are used for input and output torque transmitters in the exemplary embodiment illustrated in the figure, it is of course contemplated that any combination of gears and couplers may be used. For purposes of the present disclosure, “gearing component” refers to couplers or other gearing components with internal splines, gears or other gearing components with external splines, and/or components with both internal and external splines.

As described in detail below, transmission disconnect system 12 includes cup-shaped washer 24 to facilitate toggling of disconnect shaft 14 between the engaged and disengaged positions, while maximizing the capacity of disconnect shaft 14 to transfer torque between input coupler 18 and output gear 22.

1. Wheel Drive Unit

In the exemplary embodiment illustrated in FIGS. 2A and 2B, transmission disconnect system 12 is used to selectively engage or disengage planetary gear system 26 housed within wheel drive transmission unit 10. Planetary gear system 26 is engaged when disconnect shaft 14 is rotatably fixed to output gear 22 (FIG. 2A), which in turn drives wheel hub 28 with a substantial gear reduction relative to input coupler 18 as described in further detail below.

Wheel drive transmission unit 10 may be mounted to a vehicle frame via mounting holes 30, establishing spindle 32 as the component of transmission unit 10 that is rotationally and axially fixed with respect to the other components thereof. A powered shaft (not shown) is rotatably fixed to input coupler 18 and operably connected to a vehicle power source, such as an engine, battery bank, or the like. Inner, female splines formed along the bore of input coupler 18 engage male outer splines 34 formed along a portion of the outer surface of first end 16 of disconnect shaft 14, thereby rotatably fixing disconnect shaft 14 to input coupler 18. When disconnect shaft 14 is in the disengaged position shown in FIG. 2B, motive force provided to input coupler 18 serves only to rotate disconnect shaft 14. On the other hand, when disconnect shaft 14 is in the engaged position as shown in FIG. 2A, motive force provided to input coupler 18 is transmitted to output gear 22 via disconnect shaft 14, thereby providing driving torque to wheel hub 28 via planetary gear system 26 (as further described below).

Second end 20 of disconnect shaft 14 includes male outer splines 36, which are sized and configured to intermesh with correspondingly formed female inner splines within the bore of output gear 22 (FIG. 2A). When so engaged, disconnect shaft 14 and output gear 22 are rotatably affixed to one another such that torque is transmissible to output gear 22 from input coupler 18. Output gear 22, in turn, acts as a sun gear in planetary gear system 26, with outer splines of sun gear 22 engaging correspondingly formed outer splines on a plurality of planet gears 38. As sun gear 22 rotates, planet gears 38 orbit sun gear 22 around longitudinal axis A₁ of disconnect shaft 14 (which is coaxial with input coupler 18 and output gear 22), such that planet gears 38 circumnavigate disconnect shaft 14. Planet gears 38, in turn, are rotatably coupled to gear carrier 40 via planet shafts 42, so that the circumnavigation of planet gears 38 about sun gear 22 rotates gear carrier 40 about axis A₁.

The outer splines of planet gears 38 also engage correspondingly formed inner splines of ring gear 44, thereby causing ring gear 44 to rotate when sun gear 22 is rotating (although at a much slower speed). Ring gear 44, in turn, is affixed to wheel hub 28 (as well as to transmission cover 46) via bolt 48. Thus, wheel hub 28 rotates at the same rotational speed as ring gear 44, thereby rotating a wheel connected to wheel hub 28 (i.e., by wheel connector bolts 50).

Gear carrier 40 is also in splined engagement with outer splines formed on idler gear 52, such that rotation of gear carrier also rotates idler gear 52 as planet gears 38 circumnavigate disconnect shaft 14. Idler gear 52, in turn, meshingly engages outer splines of secondary planet gears 54, which are rotatably coupled to secondary gear carrier 56 via secondary planet shafts 58. Secondary gear carrier 56 is rotatably coupled to spindle 32, thereby facilitating circumnavigation of secondary planet gears 54 about idler gear 52. Planet gears 38, 54 cooperate with idler gear 52 and ring gear 44 to provide substantial reduction in the rotational speed of ring gear 44, and therefore also wheel hub 28, as compared with the rotational speed of input coupler 18.

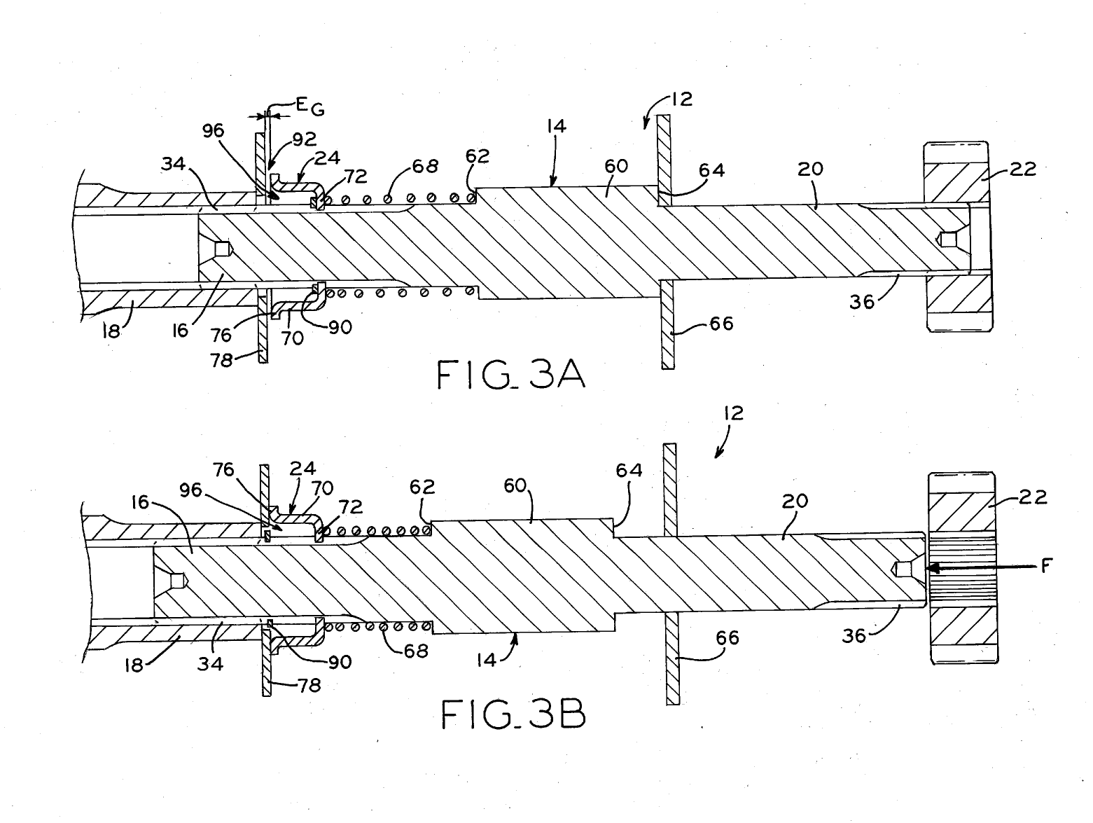

To reconfigure disconnect shaft 14 from the engaged to the disengaged position, force F (FIGS. 2B and 3B) is applied along axis A₁ to axially displace disconnect shaft 14 out of splined engagement with output gear 22 (and therefore also further into splined engagement with input coupler 18). In the illustrated embodiment, such application of force may be provided manually by the user of wheel drive transmission unit 10, i.e., by pushing on the terminal end of second end 20 of disconnect shaft 14. As used herein, “terminal end” refers to the axial terminus of a structure, (e.g., shaft 14, cup-shaped washer 24 or spring 68) beyond which no material of the structure extends. Exemplary embodiments of mechanisms which may be used to facilitate reconfiguration of disconnect shaft 14 between the engaged and disengaged positions may be found in U.S. Pat. No. 6,607,049 to Cigal filed Mar. 6, 2001 and entitled “Quick Disconnect for an Integrated Drive Unit” and U.S. Patent Application Publication No. 2012/0031212, filed May 9, 2011 and entitled “Quick Disconnect for a Drive Unit,” the entire disclosures of which are hereby expressly incorporated by reference herein.

Although transmission disconnect system 12 is illustrated in the context of wheel drive transmission unit 10 shown in FIGS. 2A and 2B and described in detail above, it is contemplated that transmission disconnect system 12 may also be used in other systems in which first and second torque transmitters axially spaced from one another are to be selectively coupled and decoupled from one another by disconnect shaft 14. Moreover, transmission disconnect system 12 may be used for any transmission application, where “transmission” refers to any mechanism for transferring motive force from an input to an output. Changes in torque and speed between the input and output, such as those changes accomplished by use of planetary gear system 26 described above, need not be performed by a transmission made in accordance with the present disclosure.

2. Transmission Disconnect System

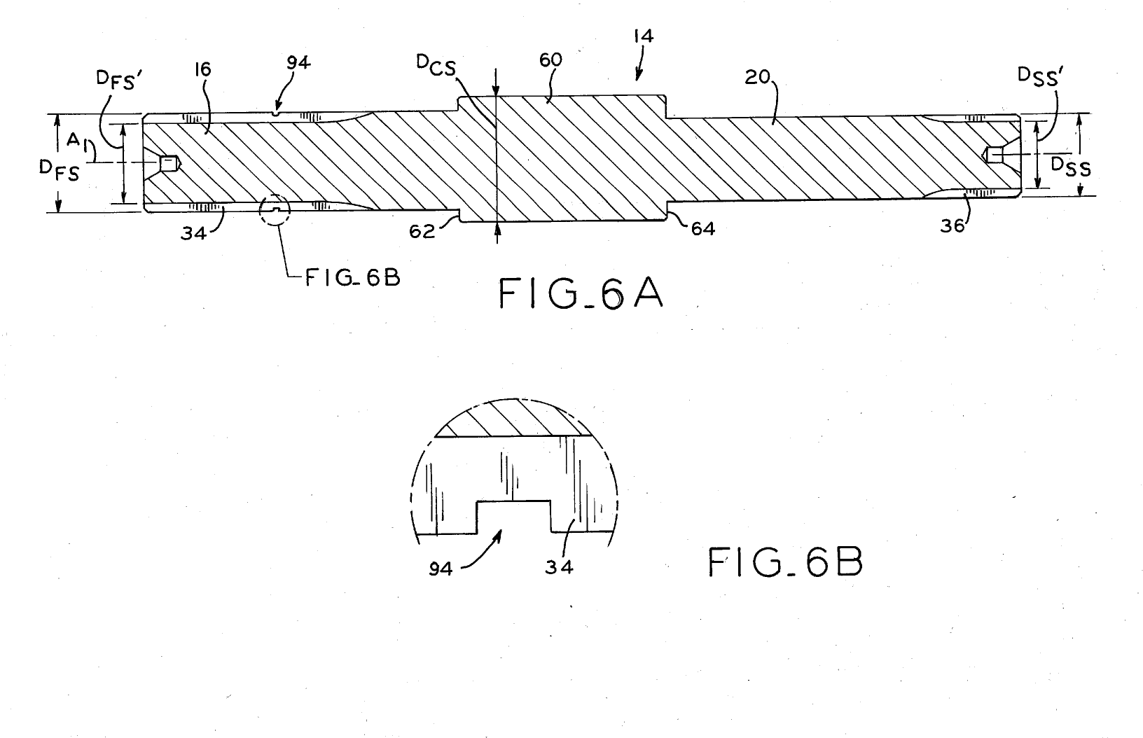

For example, turning to FIGS. 3A and 3B, disconnect shaft 14 is shown independently of most components within wheel drive transmission unit 10, illustrating only the components which interact directly with disconnect shaft 14. Broadly speaking, disconnect shaft 14 is rotatably fixed to input coupler 18 (i.e., a torque transmitter) and is selectively rotatably fixed to output gear 22 (i.e., a second torque transmitter). In the illustrated exemplary embodiment, disconnect shaft 14 includes central portion 60 having diameter D_{CS} (FIG. 6A) larger than diameters D_{FS} D_{SS} (FIG. 6A) of first and second ends 16, 20 respectively, thereby creating first shoulder 62 and second shoulder 64 at the axial ends of central portion 60. As illustrated, second shoulder 64 bears against washer 66 in the engaged position. Washer 66, in turn, is axially fixed within transmission unit 10, so that such abutment defines the end of axial travel of disconnect shaft 14 toward output gear 22. First shoulder 62 provides a bearing surface for the output-side axial end of biasing element 68, while the opposing input-side axial end of biasing element 68 abuts cup-shaped washer (as described in greater detail below).

In the illustrated embodiment, biasing element 68 is a compression spring which is slightly compressed in the engaged position of FIG. 3A and more fully compressed in the disengaged position of disconnect shaft shown in FIG. 3B. Thus, spring 68 urges disconnect shaft 14 toward its engaged position, and reconfiguration of disconnect shaft 14 into the disengaged position requires that force F (FIG. 3B) overcomes such biasing force (as well as any frictional forces which may be present on disconnect shaft 14).

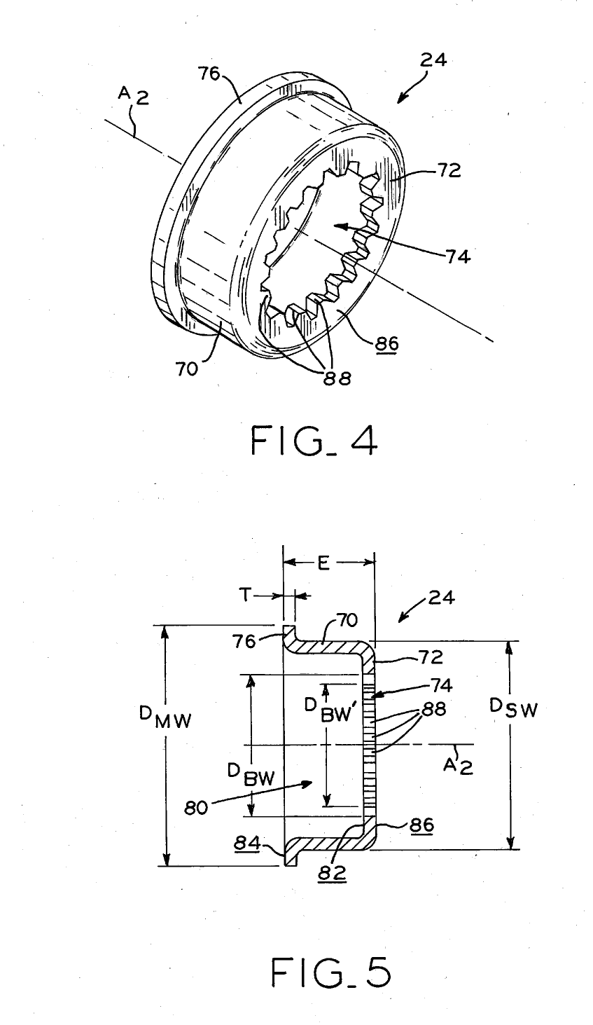

Cup-shaped washer 24 is illustrated in FIGS. 4 and 5. Washer 24 includes sidewall 70 having a generally arcuate configuration, such as a cylindrical or a slightly conical shape, such that sidewall 70 defines longitudinal axis A₂ of washer 24. However, it is appreciated that sidewall could take any cross-sectional profile while still defining a generally longitudinal structure having axis A₂. At one axial terminal end of sidewall 70 (i.e., the output-side axial end), mounting flange 72 extends radially inward toward axis A₂ and defines washer bore 74. Bore 74 includes a plurality of gear splines formed around the periphery thereof, which are sized and configured to engage outer splines 34 at first end 16 of disconnect shaft 14 as described in further detail below.

At the opposing (i.e., input-side) axial terminal end of sidewall 70, seating flange 76 extends radially outwardly away from axis A₂. This outward extension of seating flange 76 provides a generally planar seating surface 84 (FIG. 5) which bears against thrust washer 78 (FIG. 3B) and thereby maintains proper alignment and coaxiality of longitudinal axis A₁ of disconnect shaft 14 and longitudinal axis A₂ of cup-shaped washer 24 as shaft 14 moves axially through bore 74. More particularly, when seating surface 84 of seating flange 76 bears against the adjacent surface of thrust washer 78, the planar configuration of seating surface 84 and the perpendicularity of such plane with respect to longitudinal axes A₁, A₂ ensures that axes A₁, A₂ remain parallel and coincident, and thereby ensures that first end 16 of transmission shaft 14 remains able to smoothly slide within bore 74 of washer 24 without binding or creating undue friction.

Mounting 86 (FIG. 5) of mounting flange 72 provides the bearing surface for the input-side axial terminal end of spring 68. As best seen in FIG. 5, sidewall 70 of washer 24 defines cavity 80 extending axially from inner surface 82 of mounting flange 72 and seating surface 84 of seating flange 76, which provides a space for axial travel of lock ring 90 (as shown in FIGS. 3A and 3B, and described in detail below).

In the exemplary embodiment illustrated in FIG. 5, cup-shaped washer 24 defines overall axial extent E of 0.65 inches between opposing axial terminal ends thereof. Major diameter D_{MW}, defined by the radial extent of seating flange 76, is 1.72 inches. Diameter D_{SW}. defined by sidewall 70, is 1.50 inches. In this exemplary embodiment, thickness T is 0.0897 inches throughout the material of cup-shaped washer 24. Accordingly, this exemplary embodiment of washer 24 is sized and configured for use in a standard commercial wheel drive, such as transmission unit 10 shown in FIG. 2A. One such exemplary transmission unit is the Model 8 Power Wheel® Planetary Gear Drive available from Auburn Gear, Inc. of Auburn, Ind. Power Wheel® is a registered trademark of Auburn Gear, Inc. of Auburn, Ind.

Moreover, the exemplary thickness T specified above facilitates production of cup-shaped washer 24 by a stamping process, thereby facilitating production of washer 24 in large volumes at low cost, while also imparting sufficient strength and rigidity to washer 24 to ensure minimal material deformation and long service life in use. When produced by stamping, sidewall 70 includes a slight amount of draft, such that sidewall 70 is slightly conical (with diameter D_{SW} decreasing slightly toward mounting flange 72). In this exemplary stamped embodiment, washer 24 is made from steel, such as 1010 carbon steel.

Bore 74 of washer 24 is sized to allow first end 16 of disconnect shaft 14 (and outer splines 34) to be received therein upon assembly and use of transmission disconnect system 12. In the exemplary embodiment illustrated in FIGS. 3A and 4, bore 74 includes inner splines 88 formed around the periphery thereof which matingly engage outer splines 34 to rotatably fix washer 24 to disconnect shaft 14, while also having a clearance fit that allows free axial travel of washer 24 with respect to disconnect shaft 14. This rotatably fixed arrangement prevents any relative rotation of washer 24 with respect to spring 68 during operation of transmission unit 10, thereby protecting spring 68 from friction and/or torsional movement at its area of contact with mounting flange 72. However, it is contemplated that bore 74 may exclude splines 88.

Whether including or excluding splines 88, the smallest diameter defined by bore 74, i.e., minor diameter D_{BW}′ (FIG. 5), is larger than the minor diameter D_{FS}′ of first end 16 of disconnect shaft 14 (FIG. 6A), while the largest diameter defined by bore 74, i.e., major diameter D_{BW}, is also larger than major diameter D_{FS} of first end 16. This allows cup-shaped washer 24 to axially slide over the outer surface of first end 16 freely. In an exemplary embodiment, major diameter D_{FS} of first end 16 of shaft 14 (i.e., at the lands of outer splines 34) is between 0.994 inches and 0.998 inches, and the corresponding major diameter of bore 74 is equal to 1.0 inches or greater. The clearance between the respective minor diameters D_{FS}′, D_{BW}′ of first end 16 and bore 74 may be the same or similar.

In an exemplary embodiment, second end 20 of disconnect shaft 14 defines major diameter D_{SS} with a corresponding minor diameter D_{SS}′ defined by the depth of outer splines 36. Diameters D_{SS}, D_{SS}′ may be any diameters as appropriate to allow outer splines 36 to mate with the corresponding inner splines of output gear 22, and may be the same or different from diameter D_{FS} of first end 16. In one exemplary embodiment diameter D_{SS} is between 0.854 and 0.859 inches.

Diameter D_{CS} (FIG. 6A) of central portion 60 may be any diameter larger than diameters D_{FS} and D_{SS}, such as 1.30 inches in the above-described exemplary embodiment. The overall axial length L of disconnect shaft 14 may be about 9 inches in this exemplary embodiment, with first and second ends 16, 20 and central portion 60 occupying whatever portion of overall length L is needed as required or desired for a particular application. Of course, it is contemplated that disconnect shaft 14 may take on other sizes and configurations for larger or smaller applications or other alternative designs.

Lock ring 90 is provided to constrain the axial travel of cup-shaped washer 24 toward input coupler 18, as illustrated in FIG. 3A. With disconnect shaft 14 in the engaged position as shown in FIG. 3A, spring 68 is extended and cup-shaped washer 24 is biased into abutting engagement with lock ring 90 as illustrated. The axial position of lock ring 90 is designed to ensure that gap 92 is maintained between seating surface 84 of seating flange 76 and the adjacent surface of thrust washer 78 as illustrated in FIG. 3A. In an exemplary embodiment, extent E_{G} of gap 92 is between 0.010 inches and 0.016 inches. Gap 92 allows washer 24 to rotate together with disconnect shaft 14 without frictional interference from thrust washer 78, which is axially and rotationally fixed to the adjacent structures of transmission unit 10.

To retain lock ring 90 in the desired axial position upon first end 16, notch 94 may be provided along the outer surfaces or lands of outer splines 34 as shown in FIG. 6B. In an exemplary embodiment, notch 94 is 1.4 inches from the axial terminal end of first end 16, which provides proper axial spacing to create gap 92 in the engaged position of shaft 145 as described above. Notch 94 may be small, as it accommodate a relatively small lock ring 90 (e.g., a lock ring having a nominal inside diameter of 0.925 inches with a nominal thickness of 0.042 inches). Moreover, lock ring 90 may be a relatively small, thin component because lock ring 90 needs only to restrain the minimal biasing force placed upon lock ring 90 by spring 68 in its nearly fully extended configuration.

In an exemplary embodiment, notch 94 is between 0.046 and 0.052 inches wide and reduces the major diameter of splines 34 by between 0.035 and 0.045 inches. This minimal reduction in diameter and minimal overall size of notch 94 minimizes any stress riser effect which may result from the addition of notch 94, and ensures that the overall minor diameter of first end 16 of disconnect shaft 14 is the minor diameter of splines 34 rather than the minor diameter created by notch 94. Stated another way, notch 94 extends into the material of shaft 14 less than splines 34. Accordingly, the maximum torsional strength of first end 16 is the same or nearly the same both before and after notch 94 is formed in shaft 14.

When force F is applied to disconnect shaft 14 as shown in FIG. 3B, shaft 14 is reconfigured into the disengaged position. As the reconfiguration begins, axial displacement of first end 16 of shaft 14 (and therefore, also of lock ring 90) toward input coupler 18 allows seating flange 76 to come into contact with the adjacent surface of thrust washer 78. Thereafter, further axial movement of disconnect shaft 14 toward the fully disengaged position of FIG. 3B compresses spring 68, which is captured between mounting flange 72 of washer 24 and shoulder 62 of shaft 14 and constrained against axial displacement toward input coupler 18 by washer 24. As this compression occurs, lock ring 90 axially traverses the annular space 96 formed between an inner surface of sidewall 70 of washer 24 and the adjacent outer surface defined by the lands of splines 34 on first end 16 of shaft 14. Overall axial extent E (FIG. 5) of washer 24, and more particularly the axial extent of cavity 80, are sufficient to allow sufficient axial travel of lock ring 90 to fully disengage outer splines 36 of second end 20 of shaft 14 from the corresponding inner splines of output gear 22. More particularly, the axial extent of cavity 80 allows lock ring to remain within annular space 96 as disconnect shaft is reconfigured from the engaged position of FIG. 3A to the disengaged position of FIG. 3B. Meanwhile, washer 24 axially travels up outer splines 34, thereby allowing first end 16 to protrude more deeply into the bore formed within input coupler 18 while seating flange 76 remains seated upon thrust washer 78.

When force F is removed from disconnect shaft 14, spring 68 is allowed to bias outer splines 36 of second end 20 back into engagement with output gear 22. Provided such splines are properly aligned, the biasing force of spring 68 will return disconnect shaft 14 to the engaged position. As this return to the engaged position completes, lock ring 90 comes into contact with inner surface 82 of mounting flange 72, and lock ring 90 draws cup-shaped washer 24 out of engagement with thrust washer 78. This frees washer 24 to rotate without frictional interaction with thrust washer 78.

Moreover, rotation of cup-shaped washer 24 with respect to thrust washer 78 while disconnect shaft 14 is in the disengaged configuration of FIG. 3B will not occur in normal operation, as there is no normal need or benefit to apply motive force to input coupler 18 when such motive force cannot be transmitted to output gear 22. Although some such rotation may occur during maintenance or diagnostic procedures, no significant wear of cup-shaped washer 24 or thrust washer 78 will occur during operation of transmission unit 10 because no contact therebetween occurs when disconnect shaft 14 is positioned to transmit torque between input coupler 18 and output gear 22.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A transmission disconnect system comprising:
a disconnect shaft axially moveable between an engaged position and a disengaged position along a longitudinal shaft axis, the disconnect shaft comprising a first end defining a first minor diameter and a second end opposite the first end;
a first torque transmitter rotatably fixed to the first end of the disconnect shaft such that a torque is transmissible between the first torque transmitter and the disconnect shaft;
a second torque transmitter rotatably fixed to the second end of the disconnect shaft when the disconnect shaft is in the engaged position and rotatably decoupled from the second end of the disconnect shaft when the disconnect shaft is in the disengaged position, such that the torque is transmissible from the first torque transmitter to the second torque transmitter via the disconnect shaft when the disconnect shaft is in the engaged position;
a cup-shaped washer having a longitudinal washer axis, the cup-shaped washer comprising:
a sidewall having an length measured along the longitudinal washer axis; and
a mounting flange extending radially inwardly from a first terminal axial end of the sidewall to define a mounting bore having a diameter larger than the first minor diameter of the disconnect shaft, the first end of the disconnect shaft axially translatable within the mounting bore;
a second terminal axial end of the sidewall opposite the first terminal axial end and defining a seating surface transverse to the longitudinal washer axis, the second terminal axial end disposed nearer to a terminus of the first end of the disconnect shaft than the first terminal axial end when the cup-shaped washer is mounted to the disconnect shaft; and
a biasing element constrained against axial displacement by the cup-shaped washer and biasing the disconnect shaft into the engaged position.

2. The transmission disconnect system of claim 1, wherein the second terminal axial end of the cup-shaped washer has an opening defining a diameter larger than the mounting bore, such that an annular space is formed between an inner surface of the sidewall and an outer surface of the first end of the disconnect shaft.

3. The transmission disconnect system of claim 2, wherein:
the disconnect shaft comprises an annular groove formed in the first end of the disconnect shaft, the annular groove defining a root diameter larger than the first minor diameter; and
the transmission disconnect system further comprising a retaining ring received within the annular groove, the retaining ring axially positioned such that the mounting flange is constrained against axial movement toward a terminal surface of the first end of the disconnect shaft when the disconnect shaft is in the engaged position.

4. The transmission disconnect system of claim 3, wherein the retaining ring constrains movement of the mounting flange along the longitudinal shaft axis when the disconnect shaft is in the engaged position, whereby the retaining ring is received within the annular space.

5. The transmission disconnect system of claim 3, wherein the cup-shaped washer defines an overall axial length that is larger than the axial extent of engagement between the second torque transmitter and the second end of the disconnect shaft when the disconnect shaft is in the engaged position, such that the retaining ring remains within the annular groove when the when the disconnect shaft is in the engaged position and the disengaged position.

6. The transmission disconnect system of claim 1, further comprising:
a seating structure interposed between the first torque transmitter and the second torque transmitter, the seating structure having a bore large enough to allow passage of the first end of the disconnect shaft therethrough, the bore small enough to prevent passage of the cup-shaped washer therethrough; and
a retaining ring axially fixed to the first end of the disconnect shaft and axially positioned such that the seating surface of the cup-shaped washer is constrained against engagement with the seating structure when the disconnect shaft is in the engaged position, whereby the cup-shaped washer freely rotates with respect to the seating structure.

7. The transmission disconnect system of claim 1, wherein the disconnect shaft further comprises a central portion disposed between the first end and the second end, the central portion defining a shoulder extending radially outward to define a shaft major diameter, the biasing element captured between the shoulder and the mounting flange of the cup-shaped washer.

8. The transmission disconnect system of claim 1, wherein the second end of the disconnect shaft defines a second minor diameter different from the first minor diameter of the first end.

9. The transmission disconnect system of claim 1, wherein the seating surface at the second terminal axial end of the sidewall of the cup-shaped washer is substantially perpendicular to the longitudinal washer axis.

10. The transmission disconnect system of claim 1, wherein the cup-shaped washer comprises a seating flange extending radially outwardly from the second terminal axial end of the sidewall opposite the first terminal axial end, the seating flange defining the seating surface.

11. The transmission disconnect system of claim 1, wherein:
the first torque transmitter is rotatably fixed to the first end of the disconnect shaft by splined engagement between male gear splines formed on an outer surface of the first end of the disconnect shaft and female gear splines formed on an inner surface of the first torque transmitter; and
the cup-shaped washer comprises a splined surface around an inner periphery of the mounting bore, the splined surface sized to meshingly engage the male gear splines whereby the cup-shaped washer and disconnect shaft are rotatably fixed to one another.

12. The transmission disconnect system of claim 1, wherein the first torque transmitter comprises an input coupler of a wheel drive transmission unit and the second torque transmitter comprises an output gear of the wheel drive transmission unit.

13. The transmission disconnect system of claim 1, wherein the mounting flange of the cup-shaped washer constrains the biasing element against axial displacement.

14. The transmission disconnect system of claim 1, wherein the cup-shaped washer defines an overall axial length that is larger than the axial extent of engagement between the second torque transmitter and the second end of the disconnect shaft when the disconnect shaft is in the engaged position.

15. A transmission comprising:
a disconnect shaft axially moveable between an engaged position and a disengaged position along a longitudinal shaft axis, the disconnect shaft comprising:
a first end defining a first minor diameter; and
a second end opposite the first end;
an input gearing component rotatably fixed to the first end of the disconnect shaft such that a torque is transmissible between the input gearing component and the disconnect shaft;
an output gearing component rotatably fixed to the second end of the disconnect shaft when the disconnect shaft is in the engaged position and rotatably decoupled from the second end of the disconnect shaft when the disconnect shaft is in the disengaged position, such that the torque is transmissible from the input gearing component to the output gearing component via the disconnect shaft when the disconnect shaft is in the engaged position;
a cup-shaped washer having a longitudinal washer axis, the cup-shaped washer comprising:
a sidewall having an length measured along the longitudinal washer axis; and
a mounting flange extending radially inwardly from a first terminal axial end of the sidewall to define a mounting bore having a diameter larger than the first minor diameter of the disconnect shaft, the first end of the disconnect shaft axially translatable within the mounting bore;
a second terminal axial end of the sidewall opposite the first terminal axial end and defining a seating surface transverse to the longitudinal washer axis;
a seating structure interposed between the input gearing component and the output gearing component, the seating structure having a bore large enough to allow passage of the disconnect shaft therethrough, the bore small enough to prevent passage of the second terminal axial end of the cup-shaped washer therethrough; and
a biasing element captured between the cup-shaped washer and an opposing bearing surface, such that the biasing element urges the seating surface of the cup-shaped washer toward the seating structure, and urges the disconnect shaft into the engaged position.

16. The transmission of claim 15, further comprising a retaining ring axially fixed to the disconnect shaft and axially positioned such that the seating surface of the mounting flange is constrained against engagement with the seating structure when the disconnect shaft is in the engaged position, whereby the cup-shaped washer is freely rotatable with respect to the seating structure during operation of the transmission.

17. The transmission of claim 16, wherein the retaining ring constrains movement of the mounting flange along the longitudinal shaft axis when the disconnect shaft is in the engaged position, whereby the retaining ring is received within a cavity defined by the sidewall of the cup-shaped washer.

18. The transmission of claim 17, wherein the retaining ring traverses an axial distance within the cavity of the cup-shaped washer when the disconnect shaft is moved from the engaged position to the disengaged position, the cup-shaped washer engaging the seating structure during the movement of the disconnect shaft such that the retaining ring spaces away from an inner surface of the mounting flange.

19. The transmission of claim 18, wherein the axial distance is larger than the axial extent of engagement between the output gearing component and the second end of the disconnect shaft when the disconnect shaft is in the engaged position, the retaining ring remaining within the cavity when the when the disconnect shaft is in the engaged position and the disengaged position.

20. The transmission of claim 15, wherein the disconnect shaft comprises a central portion disposed between the first end and the second end, the central portion defining a shoulder extending radially outward from the longitudinal shaft axis, the shoulder comprising the opposing bearing surface.

21. The transmission of claim 15, wherein the seating surface of the cup-shaped washer has an opening defining a diameter larger than the mounting bore, such that an annular space is formed between an inner surface of the sidewall and an outer surface of the first end of the disconnect shaft.

22. The transmission of claim 21, further comprising a retaining ring axially fixed to the disconnect shaft, the disconnect shaft comprising an annular groove formed in the first end of the disconnect shaft, the annular groove defining a root diameter larger than the first minor diameter, the retaining ring received within the annular groove, the retaining ring axially positioned such that the mounting flange is constrained against axial movement toward a terminal surface of the first end of the disconnect shaft when the disconnect shaft is in the engaged position.

23. The transmission of claim 15, wherein the second end of the disconnect shaft defines a second minor diameter different from the first minor diameter of the first end.

24. The transmission of claim 15, wherein the seating surface at the second terminal axial end of the sidewall of the cup-shaped washer is substantially perpendicular to the longitudinal washer axis.

25. The transmission of claim 15, wherein the cup-shaped washer comprises a seating flange extending radially outwardly from the second terminal axial end of the sidewall, the seating flange defining the seating surface.

26. The transmission of claim 15, wherein:
the input gearing component is rotatably fixed to the first end of the disconnect shaft by splined engagement between male gear splines formed on an outer surface of the first end of the disconnect shaft and female gear splines formed on an inner surface of the input gearing component; and
the cup-shaped washer comprises a splined surface around an inner periphery of the mounting bore, the splined surface sized to meshingly engage the male gear splines whereby the cup-shaped washer and disconnect shaft are rotatably fixed to one another.

27. The transmission of claim 15, wherein the mounting flange of the cup-shaped washer constrains the biasing element against axial displacement.

28. The transmission of claim 25, wherein the cup-shaped washer defines an overall axial length that is larger than the axial extent of engagement between the output gearing component and the second end of the disconnect shaft when the disconnect shaft is in the engaged position.

29. A cup-shaped washer comprising:
an annular sidewall having an length measured along a longitudinal washer axis; and
a mounting flange extending radially inwardly from a first terminal axial end of the annular sidewall to define a mounting bore having a splined inner periphery adapted to be rotatably fixed to a splined outer surface of a shaft; and
a seating flange extending radially outwardly from a second terminal axial end of the annular sidewall opposite the first terminal axial end, the seating flange defining a seating surface transverse to the longitudinal washer axis.

30. The cup-shaped washer of claim 29, wherein the annular sidewall, the mounting flange and the seating flange all define a substantially uniform material thickness.

31. The cup-shaped washer of claim 30, wherein the substantially uniform material thickness is equal to 0.09 inches and the cup-shaped washer is formed from carbon steel, whereby the cup-shaped washer is sized and proportioned to be produced by a stamping process.

32. The cup-shaped washer of claim 29, wherein an overall axial length of the cup-shaped washer is 0.65 inches and an overall diameter of the cup-shaped washer is 1.72 inches, whereby the cup-shaped washer is sized to be received in a wheel drive transmission unit.

33. The cup-shaped washer of claim 29, wherein the seating surface of the seating flange is substantially perpendicular to the longitudinal washer axis.
